(19) United States
(12) Patent Application Publication
(10) Pub. No.: US 2025/0060557 A1
(43) Pub. Date: Feb. 20, 2025

(54) CAMERA MODULE AND VEHICLE COMPRISING SAME

(71) Applicant: LG INNOTEK CO., LTD., Seoul (KR)

(72) Inventors: Jun Young LIM, Seoul (KR); Sung Jin PARK, Seoul (KR); Se Yeon CHOI, Seoul (KR)

(21) Appl. No.: 18/721,044

(22) PCT Filed: Dec. 16, 2022
(86) PCT No.: PCT/KR2022/020652

§ 371 Date: Jun. 17, 2024

(30) Foreign Application Priority Data
Dec. 16, 2021 (KR) 10-2021-0180592

(51) Int. Cl. G02B 7/02; G03B 30/00

(52) U.S. Cl. CPC G02B 7/022; G02B 7/021; G03B 30/00

(57) ABSTRACT

The camera module disclosed in the embodiment of the invention includes a lens barrel having an opening; and a lens portion disposed within the opening and having a plurality of lenses which an optical axis is aligned from an object side toward a sensor side, wherein the lens barrel includes a lens fixing portion to which the plurality of lenses is fixed; a holder coupling portion spaced apart from the lens fixing portion; a connection frame connected between the lens fixing portion and the holder coupling portion; and a buffer space disposed between the lens fixing portion and the holder coupling portion and disposed at a lower portion of the connection frame, wherein the buffer space overlaps a flange portion of one or two lenses adjacent to the sensor side among the plurality of lenses in a horizontal direction, and the horizontal direction may be a direction orthogonal to the optical axis.

### TECHNICAL FIELD

An embodiment of the invention relates to a camera module and a vehicle having the same.

### BACKGROUND ART

ADAS (Advanced Driving Assistance System) is an advanced driver assistance system for assisting the driver to drive and is composed of sensing the situation in front, determining the situation based on the sensed result, and controlling the behavior of the vehicle based on the situation determination. For example, the ADAS sensor device detects a vehicle ahead and recognizes a lane. Then, when the target lane or target speed and the target in front are determined, the vehicle's ESC (Electrical Stability Control), EMS (Engine Management System), MDPS (Motor Driven Power Steering), etc. are controlled. Typically, ADAS may be implemented as an automatic parking system, a low-speed city driving assistance system, a blind spot warning system, and the like. The sensor devices for sensing the forward situation in ADAS are a GPS sensor, a laser scanner, a front radar, and a lidar, and the most representative is a front camera for photographing the front of the vehicle.

Recently, research on detection systems that detect the surroundings of the vehicle for driver safety and convenience is accelerating. The vehicle detection systems are used for various purposes, such as detecting objects around the vehicle to prevent collisions with objects that the driver does not recognize, as well as performing automatic parking by detecting empty spaces, and provide the most essential data for automatic vehicle control. In such a detection system, a method using a radar signal and a method using a camera are commonly used.

Vehicle camera modules are built into front and rear surveillance cameras and black boxes in cars and are used to capture subjects in photos or videos. Since vehicle camera modules are exposed to the outside, photographing quality may deteriorate due to moisture and temperature. In particular, camera modules have a problem in that their optical characteristics change depending on the surrounding temperature and the material of the lens.

### DISCLOSURE

### Technical Problem

An embodiment of the invention may provide a camera module that prevents deterioration of resolution (MTF) due to deformation of the lens barrel. An embodiment of the invention may provide a camera module that has a buffer space between the lens fixing portion of the lens barrel and the holder coupling portion, and can provide expansion space for some lenses. An embodiment of the invention may provide a mobile terminal such as a mobile terminal and a vehicle having a camera module.

### Technical Solution

A camera module according to an embodiment of the invention includes a lens barrel having an opening; and a lens portion disposed within the opening and having a plurality of lenses which an optical axis is aligned from an object side toward a sensor side, wherein the lens barrel includes a lens fixing portion to which the plurality of lenses is fixed; a holder coupling portion spaced apart from the lens fixing portion; a connection frame connected between the lens fixing portion and the holder coupling portion; and a buffer space disposed between the lens fixing portion and the holder coupling portion and disposed at a lower portion of the connection frame, wherein the buffer space overlaps a flange portion of one or two lenses adjacent to the sensor side among the plurality of lenses in a horizontal direction, and the horizontal direction may be a direction orthogonal to the optical axis.

According to an embodiment of the invention, the connection frame may overlap in the horizontal direction with a region between the flange portions of two lenses adjacent to the sensor side among the plurality of lenses.

According to an embodiment of the invention, a thickness of the connection frame may be thinner than a thickness of at least one of flange portions of the plurality of lenses. An embodiment of the invention includes a spacing member on the flange portion of the lens closest to the sensor side among the plurality of lenses, and the connection frame may overlap the spacing member in the horizontal direction.

According to an embodiment of the invention, the thickness of the connection frame may be thinner than a thickness of the spacing member. According to an embodiment of the invention, a height of the buffer space may be equal to or greater than a distance from a lower end of the lens fixing portion to an object-side surface of the flange portion of the lens closest to the image sensor. The height of the buffer space may be equal to or greater than a distance from a lower end of the lens fixing portion to a sensor-side surface of the flange portion of a lens closest to an object.

According to an embodiment of the invention, a first lens closest to the object among the plurality of lenses may be made of glass, and the two lenses adjacent to the sensor among the plurality of lenses may be made of plastic. A width of the buffer space is a distance between the lens fixing portion and the holder coupling portion, and may be 10 μm or more. The lens adjacent to the sensor among the plurality of lenses may be made of plastic. The lens closest to the object among the plurality of lenses may be made of glass.

A camera module according to an embodiment of the invention includes a lens barrel having an opening; a lens portion disposed within the opening and having first to third lenses which an optical axis is aligned from an object side to a sensor side; and a spacing member disposed on an outer periphery between the second lens and the third lens, wherein at least one of the second lens and the third lens is made of plastic, the lens barrel includes a lens fixing portion to which the first to third lenses and the spacing member are fixed; a holder coupling portion spaced apart from the lens fixing portion; a connection frame connected between the lens fixing portion and the holder coupling portion; and a buffer space disposed between the lens fixing portion and the holder coupling portion and disposed at a lower portion the connection frame, wherein the buffer space overlaps a flange portion of one or two lenses adjacent to the sensor side among the first to third lenses in a horizontal direction, and the horizontal direction may be a direction orthogonal to the optical axis.

According to an embodiment of the invention, a plurality of ribs connecting the lens fixing portion and the holder coupling portion along a surface of the connection frame may be included. The lens barrel is made of plastic, and the holder coupling portion of the lens barrel may have a fastening portion that is screwed to the holder.

According to an embodiment of the invention, the connection frame horizontally overlaps the spacing member between the second lens and the third lens, and a thickness of the connection frame may be thinner than a thickness of the spacing member. A thickness of the connection frame may be thinner than a thickness of at least one of the flange portions of the first to third lenses.

According to an embodiment of the invention, a height of the buffer space may be equal to or greater than a distance from a lower end of the lens fixing portion to an object-side surface of the flange portion of the third lens. The height of the buffer space may be equal to or greater than a distance from a lower end of the lens fixing portion to a sensor-side surface of the flange portion of the first lens. A width of the buffer space is a distance between the lens fixing portion and the holder coupling portion, and the width is equal to or greater than a value of D×CTE×(maximum operating temperature−room temperature), where D is a maximum outer diameter of the lens barrel, CTE is a thermal expansion coefficient of the third lens, the maximum operating temperature may be 80 degrees to 105 degrees, and the room temperature may be 20 degrees to 30 degrees. A difference between the maximum operating temperature and room temperature may indicate a change in temperature of the camera module or lens portion.

A vehicle or mobile terminal according to an embodiment of the invention may have the camera module.

### Advantageous Effects

According to an embodiment of the invention, a reliability of the camera module can be improved by providing a camera module that can mechanically compensate for the stress and strain of the lens. According to an embodiment of the invention, the reliability of the camera module that provides a lens fixing portion that flows in a horizontal direction orthogonal to the optical axis according to expansion or contraction of a plastic lens can be improved. According to an embodiment of the invention, the optical reliability of a camera module can be improved and the reliability of a vehicle camera device having a camera module can be improved.

### DESCRIPTION OF DRAWINGS

FIG. 1 is an example of a front view of a camera module according to an embodiment of the invention.

FIG. 2 is a rear view of the camera module of FIG. 1.

FIG. 3 is an example of a side cross-sectional view of the camera module of FIG. 1.

FIG. 4 is a partial side cross-sectional view of the camera module according to the first embodiment of the invention.

FIG. 5(A)(B) is a diagram comparing strain and stress in the camera module of FIG. 4.

FIG. 6 is a partial side cross-sectional view of a camera module according to a second embodiment of the invention.

FIG. 7(A)(B) is a diagram comparing strain and stress in the camera module of FIG. 6.

FIG. 8(A)(B) is diagrams comparing strain and stress in a camera module of comparative example.

FIG. 9 is a plan view showing an example of a vehicle having a camera module according to an embodiment of the invention.

### BEST MODE

Hereinafter, preferred embodiments of the invention will be described in detail with reference to the accompanying drawings. A technical spirit of the invention is not limited to some embodiments to be described, and may be implemented in various other forms, and one or more of the components may be selectively combined and substituted for use within the scope of the technical spirit of the invention. In addition, the terms (including technical and scientific terms) used in the embodiments of the invention, unless specifically defined and described explicitly, may be interpreted in a meaning that may be generally understood by those having ordinary skill in the art to which the invention pertains, and terms that are commonly used such as terms defined in a dictionary should be able to interpret their meanings in consideration of the contextual meaning of the relevant technology.

The terms used in the embodiments of the invention are for explaining the embodiments and are not intended to limit the invention. In this specification, the singular forms also may include plural forms unless otherwise specifically stated in a phrase, and in the case in which at least one (or one or more) of A and (and) B, C is stated, it may include one or more of all combinations that may be combined with A, B, and C. In describing the components of the embodiments of the invention, terms such as first, second, A, B, (a), and (b) may be used. Such terms are only for distinguishing the component from other component, and may not be determined by the term by the nature, sequence or procedure etc. of the corresponding constituent element. And when it is described that a component is “connected”, “coupled” or “joined” to another component, the description may include not only being directly connected, coupled or joined to the other component but also being “connected”, “coupled” or “joined” by another component between the component and the other component. In addition, in the case of being described as being formed or disposed “above (on)” or “below (under)” of each component, the description includes not only when two components are in direct contact with each other, but also when one or more other components are formed or disposed between the two components. In addition, when expressed as “above (on)” or “below (under)”, it may refer to a downward direction as well as an upward direction with respect to one element. Several embodiments described below may be combined with each other, unless it is specifically stated that they cannot be combined with each other. In addition, the description of other embodiments may be applied to parts omitted from the description of any one of several embodiments unless otherwise specified.

In the description of the invention, the first lens means the lens closest to the object side among the plurality of lenses aligned with the optical axis, and the last lens means the lens closest to the sensor side among the plurality of lenses aligned with the optical axis. In the description of the invention, all measures for the radius, thickness/distance, TTL, etc. of the lens are mm unless otherwise specified. In the present specification, the shape of the lens is shown based on the optical axis of the lens. For example, that the object-side or sensor-side surface of the lens is convex means that the optical axis vicinity is convex on the object-side or sensor-side surface of the lens, but does not mean that the optical axis periphery is convex. Accordingly, even when the object-side or sensor-side surface of the lens is described as being convex, the portion around the optical axis on the object-side or sensor-side surface of the lens may be concave. That the object-side or sensor-side surface of the lens is concave means that the vicinity of the optical axis is concave on the object-side or sensor-side surface of the lens, but does not mean that the periphery of the optical axis is concave. Accordingly, even when the object-side or sensor-side surface of the lens is described as being concave, the portion around the optical axis on the object-side or sensor-side surface of the lens may be convex. In the present specification, it should be noted that the thickness and radius of curvature of the lens are measured based on the optical axis of the lens. That is, the convex surface of the lens may mean that the lens surface of the region corresponding to the optical axis has a convex shape, and the concave lens surface means that the lens surface of the region corresponding to the optical axis has a concave shape can do. In addition, “object-side surface” may mean a surface of the lens that faces the object side with respect to the optical axis, and “sensor-side surface” may mean a surface of the lens that faces the sensor-side surface with respect to the optical axis.

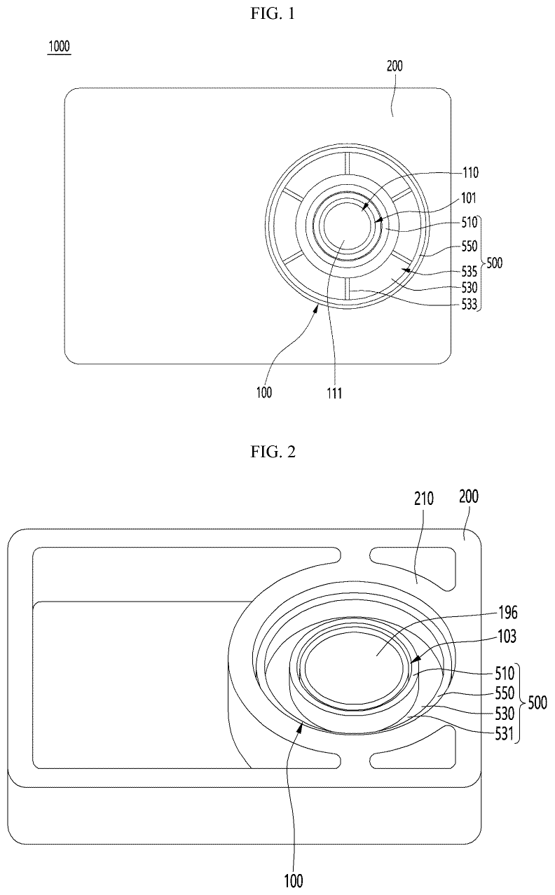

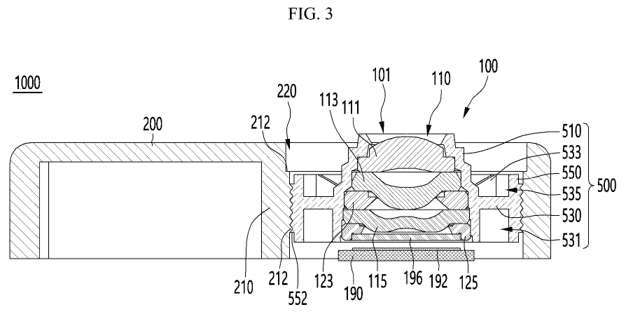

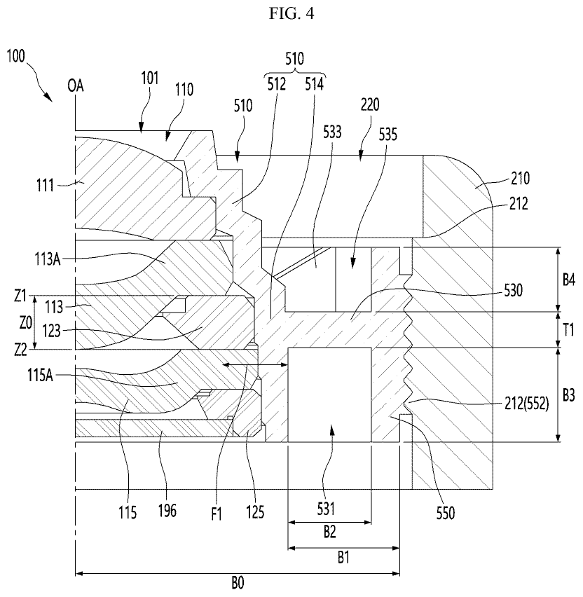

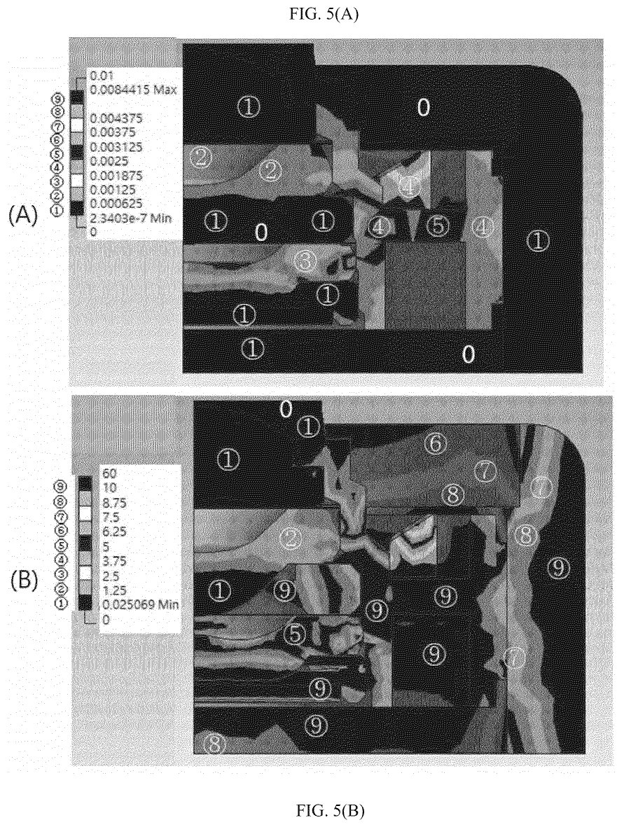

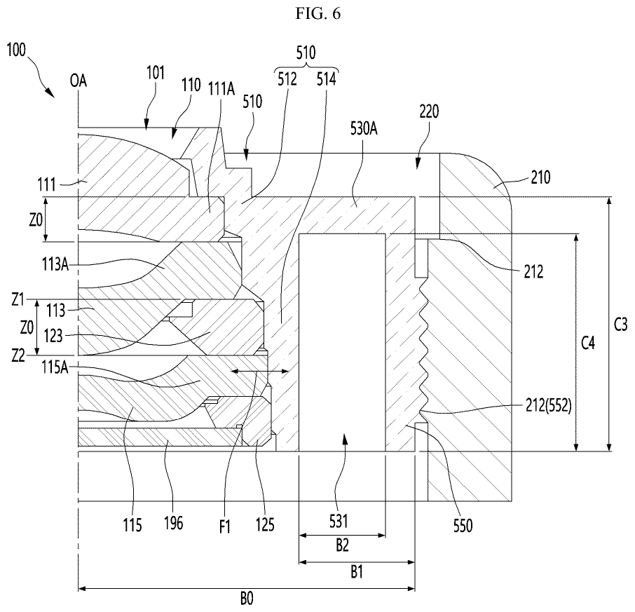

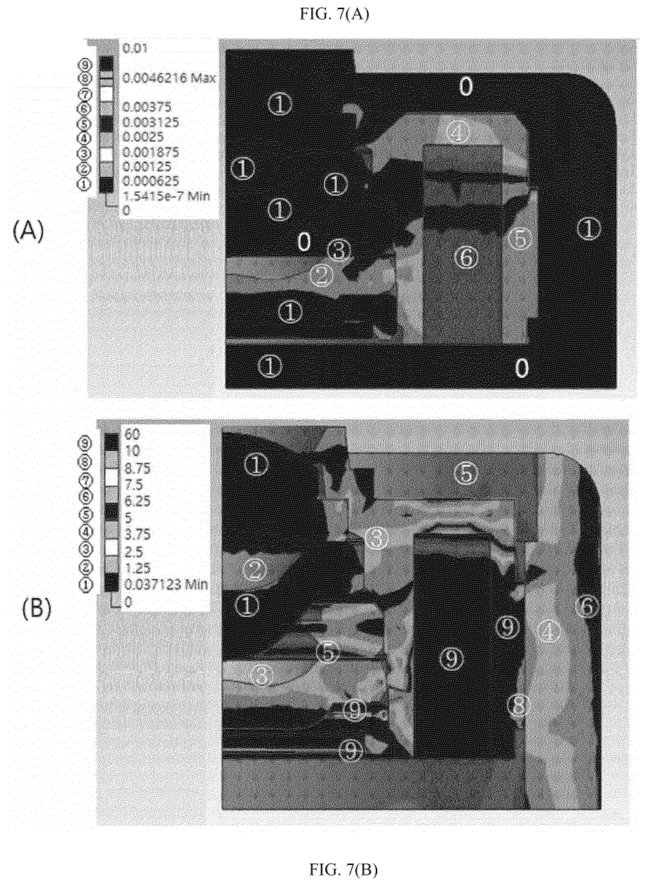

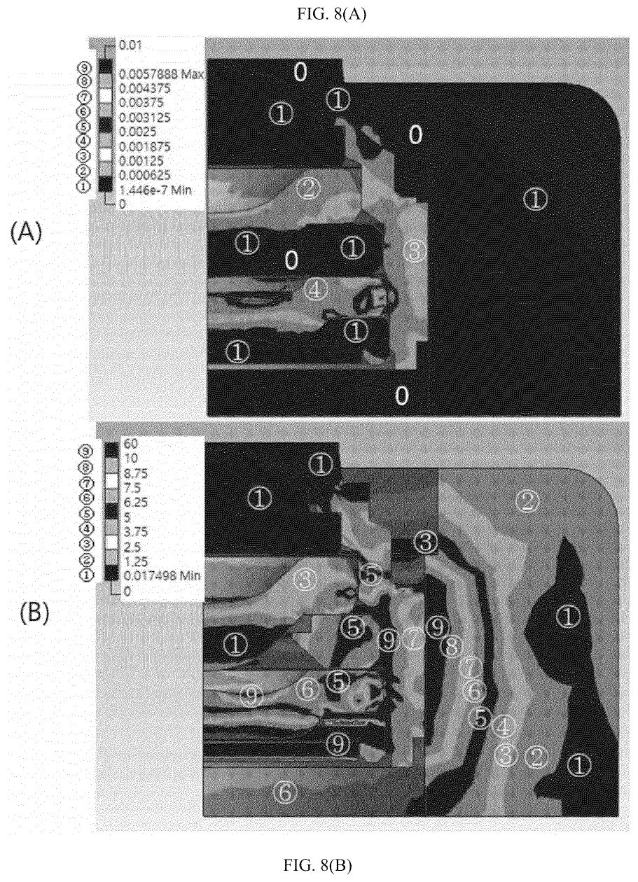

FIG. 1 is an example of a front view of a camera module according to an embodiment of the invention, FIG. 2 is a rear view of the camera module of FIG. 1, FIG. 3 is an example of a side cross-sectional view of the camera module of FIG. 1, FIG. 4 is a partial side cross-sectional view of the camera module according to the first embodiment of the invention, FIG. 5(A)(B) is a diagram comparing strain and stress in the camera module of FIG. 4, FIG. 6 is a partial side cross-sectional view of a camera module according to a second embodiment of the invention, FIG. 7(A)(B) is a diagram comparing strain and stress in the camera module of FIG. 6, and FIG. 8(A)(B) is diagrams comparing strain and stress in a camera module of comparative example.

Referring to FIGS. 1 to 3, a camera module 1000 according to an embodiment of the invention may include a lens module 100 having a lens portion 110 and a lens barrel 500, and a holder 200 for fixing the lens module 100. The lens module 100 is disposed in a holder 200, and the holder 200 may be built into various mirrors, front or rear surveillance cameras, and black boxes, etc. in the vehicle. The lens barrel 500 supports the lenses 111, 113, and 115 of the lens portion 110 disposed in the opening 101 and may be coupled to the coupling hole 220 of the holder 200. The lens module 100 may include a main substrate 190, an image sensor 192, and an optical filter 196 at a lower portion thereof. The lenses 111, 113, and 115 of the lens portion 110 are coupled to the opening 101 in the lens barrel 500, and may be coupled, for example, from the sensor side toward the object side, in the opposite direction, or in both directions. An example will be given where the lenses 111, 113, and 115 in the opening 101 of the lens barrel 500 are coupled from the sensor side toward the object side.

The lens portion 110 may be an optical system in which three or more lenses 111, 113, and 115 are stacked. The lens portion 110 may include an optical system in which five or less lenses are stacked. The lens portion 110 may include three or more or five or more solid lenses. The lens portion 110 may include at least one lens made of plastic, or may include at least one lens made of glass and a lens made of plastic. In the lens portion 110 according to an embodiment of the invention, there may be more plastic lenses than glass lenses, or the plastic lens may be two or more lenses. Here, the lens portion 110 may be laminated with plastic lenses or/and glass lens(s). Here, the coefficient of thermal expansion (CTE) of the plastic material is more than 5 times higher than that of the glass material, and the change value (|dN/dT|) of the refractive index as a function of temperature may be more than 10 times higher for the plastic material than for the glass material. Here, dN represents the change value of the refractive index of the lens, and dT represents the change value of temperature.

The lens portion 110 may include a plurality of lenses 111, 113, and 115 stacked from the object side toward the sensor side. The plurality of lenses 111, 113, and 115 may include a first lens 111 that is closest to the object side, a third lens 115 that is the last lens closest to the sensor side, and a second lens that is one or a plurality of intermediate lenses between the first lens 111 and the last lens 115. The lens portion 110 may be a mixture of a lens of plastic material and a lens of glass material. The lens made of plastic may be easily injection-molded on a lens surface and may be provided as an aspherical surface, so it can effectively change the path of incident light. When these plastic lenses are mixed, the thickness of the lens module 100 can be reduced. When such the plastic lens is mixed, the plastic lens may expand or contract, and as a result, a distance between the center of the sensor side of the last lens 115 and the image sensor 192, that is, the back focal length (BFL) changes, which may reduce the resolution (MTF).

In addition, the lens portion 110 is a mixture of a plastic lens and a glass lens. For example, the first lens 111 is a lens that is closest to the object and is greatly affected by the external environment, and may be made of a glass material with a low coefficient of thermal expansion. The second lenses 113 may be made of plastic or glass material, and when multiple lenses are arranged, one may be made of plastic material. When the second lens 113 is multiple lenses, the lens closer to the sensor side may be made of plastic material. The third lens 115 may be made of plastic material, and thus may refract incident light to the periphery portion of the image sensor 192.

The first lens 111 is the lens closest to the subject, and at least one or both of the object-side surface from which light is incident and the sensor-side surface from which light is emitted may be spherical or aspherical. On the optical axis OA, the object-side surface of the first lens 111 may be convex, and the sensor-side surface may be concave. The first lens 111 may be made of glass material. The first lens 111 may include a first flange portion 111A on the outside. A portion of the outer side of the first flange portion 111A may contact an inner surface of the lens fixing portion 510 of the lens barrel 500.

The first lens 111 may be made of glass material, and when the camera module 1000 is exposed to light from inside or outside the vehicle, discoloration due to the plastic material can be prevented and deformation caused by heat can be reduced. When the camera module 1000 is disposed in a vehicle or is not exposed to the outside of the vehicle, the first lens 111 may be made of glass or plastic. The first lens 111 may have a refractive index of 1.7 or more, 1.8 or more, or in the range of 1.7 to 2.3. The center thickness of the first lens 111 may be the thickest among the lenses of the lens portion 110, and may be, for example, 1 mm or more.

The second lens 113 and the third lens 115 may have different materials and different refractive indices from the first lens 111. The second lens 113 may be made of plastic material. The second lens 113 is disposed between the first lens 111 and the third lens 115, and may have a second flange portion 113A on the outside. The third lens 115 may be made of plastic material. The third lens 115 is disposed between the second lens 113 and the optical filter 196, and may have a third flange portion 115A on the outside. The second lens 113 and the third lens 115 may be injection molded from plastic material.

The refractive index of the second lens 113 may be lower than that of the first lens 111, and may be less than 1.7, for example, in the range of 1.45 to 1.69. The difference in refractive index between the second lens 113 and the first lens 111 may be 0.3 or more. The second lens 113 may be aspherical on both the object-side surface and the sensor-side surface. The second lens 113 may have a convex object-side surface and a concave sensor-side surface on the optical axis OA. Alternatively, second lens 113 may have a structure of a convex object-side surface and a convex sensor-side surface, or a concave object-side surface and a concave sensor-side surface. The second lens 113 may include a second flange portion 113A on the outside. A portion of the outer side of the second flange portion 113A may be in contact with the inner surface of the lens fixing portion 510 of the lens barrel 500. The second flange portion 113A extends in a direction X orthogonal to the optical axis OA from the outside of the effective diameter of the second lens 113, and the thickness of the second flange portion 113A may be a distance between two surfaces in contact with the optical member in the regions of the object side and the sensor side. The optical member may be an object disposed inside the lens barrel, such as a lens, lens barrel, spacing member, aperture stop, or light blocking film. The center thickness of the second lens 113 may be the second thickest among the lenses of the lens portion 100, for example, thinner than the center thickness of the first lens 111, and thicker than the center thickness of the third lens 115. The center distance between the second lens 113 and the first lens 111 may be smaller than the thickness of the first lens 111 and may be larger than the center distance between the second and third lenses 113 and 115.

The object-side surface and the sensor-side surface of the third lens 115 may be aspherical. The object-side surface of the third lens 115 may be concave, and the sensor-side surface may be convex on the optical axis OA. As another example, the object-side surface of the third lens 115 may be convex on the optical axis OA, and the sensor-side surface may be concave. The third lens 115 is made of plastic or glass material. When the third lens 115 is made of plastic material, it has a higher coefficient of thermal expansion than glass material, so greater thermal deformation may occur. The third lens 115 may be made of plastic material, and may have a higher thermal expansion coefficient than the material of the first lens 111. The third lens 115 may include a third flange portion 115A on the outside. The outer side of the third flange portion 115A may be in contact with the inner surface of the lens fixing portion 510 of the lens barrel 500. The thickness of the third flange portion 115A of the third lens 115 is a distance between a surface of the third flange portion 115A in contact with the second light blocking film 124 and a surface in contact with the press-fitting member 125, and the distance, for example, may be a distance in a direction parallel to the optical axis.

When the third lens 115 is made of plastic material, the refractive index of the third lens 115 may be lower than that of the first lens 111, and may be less than 1.7, for example, in the range of 1.45 to 1.69. The materials of the second and third lenses 113 and 115 may have the same or different refractive indices. The difference in refractive index between the third lens 115 and the first lens 111 may be 0.3 or more. The center thickness of the third lens 115 may be thinner than the center thickness of the first lens 111 and thinner than the center thickness of the second lens 113. The center distance between the third lens 115 and the second lens 113 may be greater than the center distance between the first and second lenses 111 and 113. The center distance between the third lens 115 and the optical filter 196 may be smaller than the center distance between the second and third lenses 113 and 115. When the third lens 115 is made of plastic material, the third lens 115 has a higher thermal expansion coefficient higher than that of glass material, and thus deformation may be greater due to heat.

The lens barrel 500 may be made of plastic material. The lens barrel 500 may have a lens fixing portion 510 having an opening 101 penetrating from the object side surface to the sensor side surface, and the holder coupling portion 550 on the outside. The upper width of the opening 101 may be smaller than the width of the lower opening 103. This may be combined by inserting a plurality of lenses 111, 113, and 115 through the lower opening 103 of the lens barrel 500. The lens module 100 may include a spacer (not shown) and a spacing member 123 between the plurality of lenses 111, 113, and 115. The spacing member 123 may be disposed between the second and third flange portions 113A and 115A of the two adjacent lenses 113 and 115 in order to space the two adjacent lenses 113 and 115 apart.

A press-fitting member 125 is disposed around the lower portion of the third flange portion 115A of the third lens 115, and the press-fitting member 125 may fix the lens fixing portion 510 of the lens barrel 500 and the third flange portion 115A of the third lens 115 and may be adhered with an adhesive (not shown). The inner diameter of the press-fitting member 125 may be smaller than the diameter of the optical filter 196, and the outer diameter may be larger than the diameter of the optical filter 196. The press-fitting member 125 has a ring shape and may be made of metal or non-metallic material.

The lens module 100 may include an optical cover glass (not shown) or/and an optical filter 196 between the last third lens 115 of the lens portion 110 and the image sensor 192. The image sensor 192 may be disposed on the main substrate 190. The image sensor 192 may be mounted, seated, contacted, fixed, temporarily fixed, supported, or coupled to the main substrate 190 on a plane intersecting the optical axis OA. Alternatively, according to another embodiment, a groove or a hole (not shown) which may accommodate the image sensor 192 may be formed in the main substrate 190, and an embodiment is not limited to a specific form in which the image sensor 192 is disposed on the main substrate 180. The main substrate 190 may be a rigid PCB or an FPCB.

The image sensor 192 may perform a function of converting light passing through the lens portion 110 into image data. A sensor barrel is disposed at lower portion of the lens barrel 500 to surround the image sensor 192 and protect the image sensor 192 from external foreign substances or impacts. The image sensor 192 may be one of a charge coupled device (CCD), complementary metal-oxide semiconductor (CMOS), CPD, or CID. When there are multiple image sensors 192, one may be a color (RGB) sensor and the other may be a black-and-white sensor.

The optical filter 196 may be disposed between the lens portion 110 and the image sensor 192. The optical filter 196 may filter light corresponding to a specific wavelength range for light passing through the lenses 111, 113, and 115. The optical filter 196 may be an infrared (IR) blocking filter that blocks infrared rays or an ultraviolet (UV) blocking filter that blocks ultraviolet rays, but the embodiment is not limited thereto. The optical filter 196 may be disposed on the image sensor 192. A cover glass (not shown) is disposed between the optical filter 196 and the image sensor 192, protects the upper portion of the image sensor 192, and prevents the reliability of the image sensor 192 from deteriorating.

The camera module 1000 according to an embodiment of the present invention may include a driving member (not shown), and the driving member may move or tilt a barrel having at least one of the lenses in an optical axis direction or/and a direction orthogonal to the optical axis direction. The camera module may include an auto focus (AF) function or/and an optical image stabilizer (OIS) function. The camera module 1000 according to an embodiment of the invention may be applied to an infrared camera or a driver monitoring camera. Additionally, the field of view of the camera module 1000 may be 50 degrees or more, for example, in the range of 50 to 70 degrees.

Here, when the lens module 100 is stacked by mixing plastic lenses and at least one glass lens, thermal deformation occurs due to the plastic lenses, the resulting heat deformation may be absorbed to minimize a change in BFL. When the second and third lenses 113 and 115 include a plastic material, the MTF change rate of diffraction optical performance at high temperatures (e.g., 80 to 105 degrees) compared to room temperature (e.g., 20 to 30 degrees) may be provided as 10% or less by providing a lens barrel 500 that may absorb or buffer thermal deformation of the second and third lenses 113 and 115 made of a plastic material. The high temperature may include the temperature inside or outside the vehicle. The lens module 100 may be coupled to the holder 200 by the lens barrel 500. The lens barrel 500 may be made of plastic, the holder 200 may be made of metal, and the lens barrel 500 may be affected by thermal deformation caused by the lens made of plastic. When this metal material is directly transferred to the guide portion 210 of the holder 200, there is a problem that the thermal deformation of the plastic material is not absorbed and the BFL changes.

An embodiment of the invention is provided with a buffer space 531 in the lens barrel 500 to absorb or buffer heat deformation transmitted from the plastic lens, such as the third lens 115, toward the guide portion 210 of the holder 200. The lens barrel 500 may include a lens fixing portion 510 disposed around the outer periphery of the lens portion 110, a holder coupling portion 550 spaced apart from the lens fixing portion 510 and coupled to the guide portion 210 of the holder 200, and a buffer space 531 between the lens fixing portion 510 and the holder coupling portion 550.

The inner surface of the lens fixing portion 510 is disposed along the outer circumference of the radius of the lenses 111, 113, and 115, and the opening 101 of the lens fixing portion 510 may be provided in a step structure so that the diameter gradually increases from the upper portion toward the lower portion. The outer surface of the lens fixing portion 510 may have a predetermined thickness and may be provided in a form that extends along the inner surface, for example, in a step structure. The holder coupling portion 550 may be disposed parallel to the lower portion 514 of the lens fixing portion 510. The lower end of the lens fixing portion 510 may be spaced apart from the main substrate 190 or may not be fixed. The lower end of the holder coupling portion 550 may be fixed to the main substrate 190 or may be spaced apart. The lower end of the lens fixing portion 510 may be a free end. The holder coupling portion 550 may have a first fastening portion 552 disposed on its outer surface. The first fastening portion 552 may be fastened to the second fastening portion 212 disposed in the coupling hole 220 of the holder 200. The first and second fastening portions 552 and 212 may be coupled in a thread structure. The upper and lower ends of the first and second fastening portions 552 and 212 may be lower than a horizontal straight line at the center of the object-side surface of the first lens 111 closest to the object side, and may be disposed higher than a horizontal straight line of the object-side surface of the optical filter 196.

The lens barrel 500 may be provided with a connection frame 530 connecting the lens fixing portion 510 and the holder coupling portion 550. The connection frame 530 may be formed continuously or discontinuously along the circumference of the outer surface of the lens fixing portion 510. When the connection frame 530 is discontinuous, a plurality of connection frames 530 may be disposed around the outer surface of the lens fixing portion 510. The connection frame 530 has a thickness greater than the minimum distance between the inner surface and the outer surface of the lens fixing portion 510, and can stably support the holder coupling portion 550 and the lens fixing portion 510.

The connection frame 530 may be disposed between the buffer space 531 and the upper groove 535. A rib 533 may be disposed on the connection frame 530. The ribs 533 are respectively disposed on the connection frame 530 and may extend from the upper outer surface of the lens fixing portion 510 to the upper inner surface of the holder coupling portion 550. The ribs 533 are arranged in a radial direction based on the optical axis, so that they stably support the connection frame 530 and can strengthen the support force of the holder coupling portion 550. The outer side of the rib 533 may extend to the upper end of the holder coupling portion 550, and the inner side may extend to the vertical upper end of the inner surface of the lens fixing portion 510. The outer height of the rib 533 may be higher than the inner height. As another example, one or more lower ribs may be disposed between the lower surface of the connection frame 530 and the holder coupling portion 550.

The lens fixing portion 510, holder coupling portion 550, connection frame 530, and rib 533 of the lens barrel 550 may be injection molded as one body. The upper end of the lens fixing portion 550 may be disposed lower than the upper end 212 of the inner coupling hole 220 of the guide portion 210 of the holder 200. The connection frame 530 may be located in a region that does not overlap with the flange portions 111A, 113A, and 115A of the plurality of lenses 111, 113, and 115 in a horizontal region orthogonal to the optical axis OA. That is, the connection frame 530 may be disposed in a region that does not overlap in the horizontal direction with the third flange portion 115A of the third lens 115 that is thermally deformed. The connection frame 530 may overlap the spacing member 123 in the horizontal direction. The connection frame 530 may be disposed between the virtual straight line Z1 extending from the sensor-side surface of the second flange portion 113A of the second lens 113 and the virtual straight line Z2 extending from the object-side surface of the third flange portion 115A of the third lens 115.

The thickness T1 of the connection frame 530 may be smaller than the thickness Z0 of the spacing member 123. The thickness T1 of the connection frame 530 may be thinner than the thickness of at least one of the flange portions 111A, 113A, and 115A of the plurality of lenses 111, 113, and 115. The thickness T1 of the connection frame 530 may be smaller than a distance between the second and third flange portions 113A and 115A of the second and third lenses 113 and 115. The lower surface of the connection frame 530 may be positioned higher than a virtual straight line Z2 extending horizontally from the object-side surface of the third flange portion 115A of the third lens 115. The upper surface of the connection frame 530 may be positioned lower than the virtual straight line Z1 extending horizontally from the sensor-side surface of the second flange portion 113A of the second lens 113. Here, the thickness Z0 of the spacing member 123 may be greater than the thickness of at least one of the first to third flange portions 111A, 113A, and 115A. At least one of the first to third flange portions 111A, 113A, and 115A may be in a range of 0.6 mm to 1.2 mm or 0.6 mm to 1 mm.

The buffer space 531 may be disposed in the internal space between the lens fixing portion 510 and the holder coupling portion 550. The lower portion between the lens fixing portion 510 and the holder coupling portion 550 is open and may be connected to the buffer space 531. The width B2 of the buffer space 531 may consider the outer diameter of the lens barrel 500, the thermal expansion coefficient of the lens barrel 500, and temperature change (maximum operating temperature−room temperature), for example, the width B2 may be equal to or greater than the value of D×CTE×(maximum operating temperature−room temperature). Here, the D is the maximum outer diameter (B0×2) of the lens barrel 500, that is, the outer diameter of the holder coupling portion 550, and may be 10 mm or more, for example, in the range of 10 mm to 15 mm. the B0 is a radius of the lens barrel 500. The CTE may be a coefficient of thermal expansion of a plastic lens or barrel in the lens barrel 500 or the lens module 100, and may be, for example, in the range of 58 to 95 ppm/° C. The maximum operating temperature may be the maximum temperature that can be generated in the lens module 100, for example, in the range of 80 degrees to 105 degrees, and the room temperature may be in the range of 20 degrees to 30 degrees. The width B2 of the buffer space 531 may be 10 μm or more, for example, in the range of 10 μm to 100 μm. The difference between the maximum operating temperature and room temperature may indicate a change in temperature of the camera module 1000 or the lens portion 100.

The buffer space 531 may be disposed in a region overlapping with one or two lenses of the plurality of lenses 111, 113, and 115 close to the sensor, among the horizontal regions orthogonal to the optical axis OA. The buffer space 531 may overlap the third lens 115 in the horizontal direction. Accordingly, when the third lens 115 is thermally deformed F1 in the horizontal direction, the buffer space 531 may provide a space in which the lower portion 114 of the lens fixing portion 510 of the lens barrel 500 may flow to the outer portion. Accordingly, when the third lens 115 expands or contracts in the horizontal direction, the problem of deviating from the optical axis OA can be solved, and a distance (BFL) between the center of the sensor-side surface of the third lens 115 and the image sensor 192 may not change. Accordingly, it is possible to prevent a decrease in resolution due to thermal deformation of the third lens 115. Here, the sensor-side surface of the second flange portion 113A of the second lens 113 may be disposed higher than the upper end of the rib 533. Accordingly, the upper portion 512 of the lens fixing portion 510 may flow through the upper groove 531 due to thermal deformation of the second lens 113. Accordingly, when the second lens 113 is expanded or contracted in the horizontal direction, a problem deviating from the optical axis OA may be solved, and an optical axis distance between the second lens 113 and the third lens 115 may not be changed. Therefore, a decrease in resolution due to thermal deformation of the second lens 113 may be prevented. Accordingly, it is possible to prevent a decrease in resolution due to thermal deformation of the second lens 113.

Here, the depth or height B3 of the buffer space 531 may be greater than a distance from the lower end of the lens barrel 510 or the lower end of the holder coupling portion 550 to the upper end of the third flange portion 115A of the third lens 115. The depth B4 of the upper groove 535 is a distance from the upper end of the holder coupling portion 550 to the bottom of the connection frame 530, and may be smaller than the height B3 of the buffer space 531. The outer center of the connection frame 530 may be disposed at a position that is ½ or more of the vertical length of the holder coupling portion 550. The height B3 of the buffer space 531 may be 20% or more, for example, 20% to 50% of the vertical distance from the lower end to the upper end of the lens barrel 500. The height B3 of the buffer space 531 may be equal to or greater than the distance from the lower end of the lens fixing portion 510 to the object-side surface of the flange portion 115A of the lens 115 closest to the sensor side. Here, the outer diameter of the lens barrel 500 may be more than 1.5 times larger than the height of the lens barrel 500, and for example, it may be more than 1.5 times the total top length (TTL). The TTL is an optical axis distance from the object-side surface of the first lens 111 to the image sensor 192. Accordingly, a slim camera module can be provided. The width B2 of the buffer space 531 may be 50% or more of the distance B1 from the outer surface of the lower portion 514 of the lens fixing portion 510 to the outer surface of the holder coupling portion 550, for example, in a range of 50% to 80%. The width B2 of the buffer space 531 may be a size that allows the plastic lens to expand from the inside of the lens fixing portion 510 to the outside. The buffer space 531 may have a width B2 sufficient to absorb or interact with the size of expansion caused by temperature changes of the internal plastic lens, and may provide the width B2 that may not be transmitted to the lens fixing portion 510 by a fastening force pressed inward when the external holder coupling portion 550 is fastened.

With reference to FIGS. 5 and 8, strain and stress of the first embodiment and comparative example of the invention will be described.

The structure of the lens barrel of FIG. 4 may appear as the strain of FIG. 5(A) and the stress of FIG. 5(B), and FIG. 8(A)(B) is a diagram showing strain and stress in the structure of the lens barrel of the comparative example without a buffer space. Comparing the strain in FIG. 5(A) and FIG. 8(A), it may be seen that the strain in the third flange portion 115A of the third lens 115 in FIG. 5(A), which is the first embodiment, is lower than that of the comparative example. In addition, when comparing the stress of FIG. 5(B) and FIG. 8(B), it may be seen that the stress in the third lens 115 in FIG. 5(B) of the first embodiment is lower than that of the comparative example. This can be linked to the expansion or contraction of the outer third flange portion 115A of the third lens 115 by the buffer space 531, thereby minimizing the problem caused by heat deformation transferred to the plastic lens.

As shown in FIG. 6, in the structure of the lens barrel 500 according to the second embodiment, the connection frame 530A may be disposed in a different position from that of the first embodiment.

Referring to FIG. 6, the connection frame 530A may be disposed in a region that overlaps the first lens 111 in the horizontal direction. The connection frame 530A may overlap the outside of the flange portion of the first lens in the horizontal direction. That is, the connection frame 530A may overlap the flange portion of the glass lens in the horizontal direction. The connection frame 530A may not overlap the flange portion of the plastic lens in the horizontal direction. The lower surface of the connection frame 530A may be disposed higher than the object-side surface of the second flange portion 113A of the second lens 113. The lower surface of the connection frame 530A may be disposed higher than the object-side surface of the flange portion of the plastic lens adjacent to the glass lens.

The thickness T1 of the connection frame 530A may be equal to or smaller than the thickness T2 of the first flange portion 111A of the first lens 111. The thickness T1 of the connection frame 530A may be smaller than the thickness Z0 of the spacing member 123. The upper end of the connection frame 530A may be positioned higher than the inner upper end 212 of the coupling hole 220 of the guide portion 210. The outer upper end of the connection frame 530A may be disposed at the same position as the outer upper end of the holder coupling portion 550. One or more lower ribs (not shown) may be disposed between the lower surface of the connection frame 530A and the holder coupling portion 550.

A thickness of a region of the lens fixing portion 510 overlapping the second flange portion 113A of the second lens 113 in the horizontal direction may be greater than a thickness of a region of the third lens 115 overlapping the third flange portion 115A of the third lens 115 in the horizontal direction to support the connection frame 530. The thickness of the lens fixing portion 510 may be the horizontal distance between the inner surface and the outer surface. The height C4 of the buffer space 531 may be equal to or greater than the distance from the lower end of the lens fixing portion 510 to the sensor-side surface of the flange portion 111A of the first lens 111 closest to the object. The height C4 of the buffer space 531 may be 70% or more, for example, 80% or more of the distance C3 from the lower end to the upper end of the holder coupling portion 550. The height C4 of the buffer space 531 may be 50% or more of the vertical distance from the lower end to the upper end of the lens barrel 500, for example, in the range of 50% to 80%.

The buffer space 531 may be disposed in a space between the lens fixing portion 510 and the holder coupling portion 550. The lower portion between the lens fixing portion 510 and the holder coupling portion 550 is open and can be connected to the buffer space 531. The width B2 of the buffer space 531 may consider the outer diameter (B0×2) of the lens barrel 500, the thermal expansion coefficient of the lens barrel 500, and temperature change, for example, the width may be equal to or greater than the value of CTE×(maximum operating temperature−room temperature). Here, D is the outer diameter of the lens barrel 500, that is, the outer diameter of the holder coupling portion 550, and may be 10 mm or more, for example, in the range of 10 mm to 15 mm. The CTE may be a coefficient of thermal expansion of the lens barrel 500 or a plastic lens or barrel within the lens module. The maximum operating temperature may be the maximum temperature that can be generated in the lens module, for example, 80 degrees to 105 degrees, and the room temperature may be 20 degrees to 30 degrees. The width B2 of the buffer space 531 may be 10 μm or more, for example, in the range of 10 μm to 100 μm. The difference between the maximum operating temperature and room temperature may indicate a change in temperature of the camera module 1000 or the lens portion 100. Here, the outer diameter of the lens barrel 500 may be more than 1.5 times larger than the height of the lens barrel 500, and for example, it may be more than 1.5 times the total top length (TTL). The TTL is the optical axis distance from the object-side surface of the first lens 111 to the image sensor 192. Accordingly, a slim camera module can be provided.

The width B2 of the buffer space 531 may be a size that allows the plastic material to expand outward from the lower end of the lens fixing portion 510. The buffer space 531 may have the width B2 sufficient to absorb or interact with the size of expansion caused by temperature changes of the internal plastic lens, and may provide a width B2 that may not be transmitted to the lens fixing portion 510 by a fastening force inward when the external holder coupling portion 550 is fastened. The buffer space 531 may be disposed in a region overlapping with two lenses of the plurality of lenses 111, 113, and 115 close to the sensor among the horizontal regions orthogonal to the optical axis OA. The buffer space 531 may overlap the second and third lenses 113 and 115, that is, the second and third flange portions 113A and 115A, in the horizontal direction. Accordingly, when the second and third lenses 113 and 115 are thermally deformed (F1), the buffer space 531 may provide a space in which the lower portion 514 of the lens fixing portion 510 of the lens barrel 500 to flow outward. Accordingly, since the second and third lenses 113 and 115 expand or contract in the horizontal direction, the problem of deviating from the optical axis OA may be solved, and the center of the sensor-side surface of the third lens 115 and the image sensor 192 may not be changed. Accordingly, it is possible to prevent resolution deterioration due to thermal deformation F1 of the second and third lenses 113 and 115.

As another example, the positions of the connection frames 530 and 530A may be connected between the lower end of the lens fixing portion 510 and the lower end of the holder coupling portion 550. Since the connection frame is disposed at the lower end of the lens barrel 500, the buffer space can be placed at the upper portion of the connection frame. The connection frame may be disposed in a region that overlaps the optical filter 196 in the horizontal direction. Accordingly, since the plastic lens flows according to temperature changes, the thermal shock transmitted from the inside to the outside can be alleviated, and the physical shock transmitted to the inside when fastened externally can be alleviated.

With reference to FIGS. 7 and 8, strain and stress of the second embodiment of the invention and the comparative example will be described.

The structure of the lens barrel in FIG. 6 may appear as the strain in FIG. 7(A) and the stress in FIG. 7(B). FIG. 8(A)(B) are diagrams showing strain and stress in the structure of a comparative example lens barrel without a buffer space. Comparing the strain of FIG. 7(A) and FIG. 8(A), it may be seen that the strain of the second and third lenses 113 and 115 in FIG. 7(A) of the second embodiment is lower than that of the comparative example. In addition, when comparing the stresses of FIG. 7(B) and FIG. 8(B), it may be seen that the stresses of the second and third lenses 113 and 115 in FIG. 7(B) of the second embodiment are lower than those of the comparative example. This can be linked to the expansion or contraction of the outer flange portions 113A and 115A of the second and third lenses 113 and 115 by the buffer space 531, thereby minimizing the problem caused by heat deformation transferred to the plastic lens.

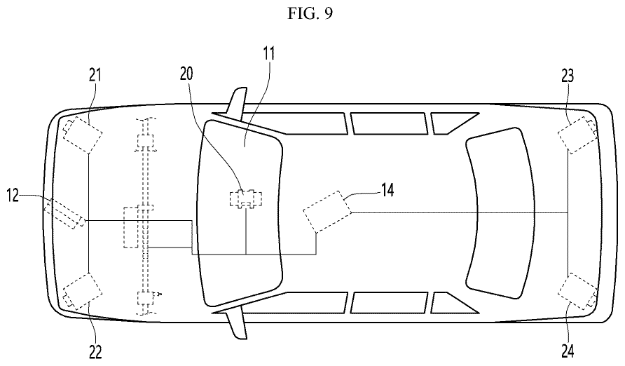

FIG. 9 is an example of a top view of a vehicle to which a camera module according to an embodiment of the invention is applied.

Referring to FIG. 9, the vehicle camera system according to an embodiment of the invention includes an image generating unit 11, a first information generating unit 12, second information generating units 21, 22, 23, 24, and a control unit 14. The image generating unit 11 may include at least one camera module 20 disposed in the own vehicle, and may generate a front image of the own vehicle or an image inside the vehicle by photographing the front and/or driver of the own vehicle. In addition, the image generating unit 11 may generate an image captured by the driver or the surroundings of the own vehicle in one or more directions as well as in front of the own vehicle by using the camera module 20. Here, the front image and the surrounding image may be a digital image, and may include a color image, a black-and-white image, and an infrared image. In addition, the front image and the surrounding image may include a still image and a moving image. The image generating unit 11 provides the driver image, the front image, and the surrounding image to the control unit 14. Next, the first information generating unit 12 may include at least one radar and/or a camera disposed on the own vehicle, and generates first sensing information by detecting the front of the own vehicle. Specifically, the first information generating unit 12 is disposed in the own vehicle, and generates the first sensing information by detecting the positions and speeds of vehicles located in front of the own vehicle, the presence and location of pedestrians, and the like.

By using the first sensing information generated by the first information generating unit 12, it is possible to control to maintain a constant distance between the own vehicle and the vehicle in front, and the stability of vehicle operation may be improved in a preset specific case, such as when the driver wants to change the driving lane of the own vehicle or when reverse parking. The first information generating unit 12 provides the first sensing information to the control unit 14. The second information generating unit 21, 22, 23, 24 detect each side of the own vehicle and generate second sensing information based on the front image generated by the image generating unit 11 and the first sensing information generated by the first information generating unit 12. Specifically, the second information generating units 21, 22, 23, and 24 may include at least one radar and/or camera disposed on the own vehicle, and detect the positions and speeds of vehicles located on the side of the own vehicle, or may take a video. Here, the second information generating units 21, 22, 23, and 24 may be disposed on both sides of the front and rear of the own vehicle, respectively. Such the vehicle camera system may include the following camera module, and may protect the vehicle and objects from automatic driving or surrounding safety by providing or processing information obtained through the front, rear, each side or corner region of the own vehicle to the user.

One or more camera modules according to an embodiment of the present invention may be mounted in a vehicle for safety regulation, reinforcement of autonomous driving functions, and increase convenience. In addition, the optical system of the camera module is a part for control such as a lane keeping assistance system (LKAS), a lane departure warning system (LDWS), and a driver monitoring system (DMS), and is applied in a vehicle. Such a vehicle camera module may realize stable optical performance even when ambient temperature changes and provide a module with competitive price, thereby securing reliability of vehicle components.

Features, structures, effects, etc. described in the above embodiments are included in at least one embodiment of the invention, and are not necessarily limited to only one embodiment. Furthermore, features, structures, effects, etc. illustrated in each embodiment may be combined or modified for other embodiments by those of ordinary skill in the art to which the embodiments belong. Accordingly, the contents related to such combinations and modifications should be interpreted as being included in the scope of the invention. In addition, although the embodiment has been described above, it is only an example and does not limit the invention, and those of ordinary skill in the art to which the invention pertains are exemplified above in a range that does not depart from the essential characteristics of the present embodiment. It may be seen that various modifications and applications that have not been made are possible. For example, each component specifically shown in the embodiment may be implemented by modification. And the differences related to these modifications and applications should be construed as being included in the scope of the invention defined in the appended claims.

1. A camera module comprising:
a lens barrel having an opening; and
a lens portion disposed within the opening and having a plurality of lenses in which an optical axis is aligned from an object side to a sensor side,
wherein the lens barrel comprises:
a lens fixing portion in which the plurality of lenses are fixed;
a holder coupling portion spaced apart from the lens fixing portion;
a connection frame connected between the lens fixing portion and the holder coupling portion; and
a buffer space disposed between the lens fixing portion and the holder coupling portion and disposed at a lower portion of the connection frame,
wherein the buffer space horizontally overlaps a flange portion of one or two lenses adjacent to the sensor side among the plurality of lenses,
wherein the horizontal direction is a direction orthogonal to the optical axis, and
wherein a thickness of the connection frame is thinner than a thickness of at least one of flange portions of the plurality of lenses.

2. The camera module of claim 1, wherein the connection frame horizontally overlaps a region between flange portions of the two lenses adjacent to the sensor side among the plurality of lenses.

3. (canceled)

4. The camera module of claim 1, comprising a spacing member on a flange portion of a lens closest to the sensor side among the plurality of lenses, and
wherein the connection frame overlaps the spacing member in the horizontal direction.

5. The camera module of claim 4, wherein a thickness of the connection frame is thinner than a thickness of the spacing member.

6. The camera module of claim 1,
wherein a height of the buffer space is equal to or greater than a distance from a lower end of the lens fixing portion to an object-side surface of the flange portion of the lens closest to a sensor.

7. The camera module of claim 1,
wherein a height of the buffer space is equal to or greater than a distance from a lower end of the lens fixing portion to a sensor-side surface of a flange portion of a lens closest to an object.

8. The camera module of claim 7, wherein the first lens closest to the object among the plurality of lenses is made of glass,
A camera module in which two lenses adjacent to the sensor among the plurality of lenses are made of plastic.

9. The camera module of claim 1, wherein a width of the buffer space is a distance between the lens fixing portion and the holder coupling portion and is 10 μm or more.

10. The camera module of claim 1, wherein a lens adjacent to a sensor among the plurality of lenses is made of plastic.

11. The camera module of claim 10, wherein a lens closest to an object among the plurality of lenses is made of glass.

12. A camera module comprising:
a lens barrel having an opening; and
a lens portion disposed within the opening and having first to third lenses in which an optical axis is aligned from an object side to a sensor side; and
a spacing member disposed around an outer circumference between the second lens and the third lens,
wherein at least one of the second lens and the third lens is made of plastic,
wherein the lens barrel includes a lens fixing portion inside to which the first to third lenses and the spacing member are fixed; a holder coupling portion spaced apart from the lens fixing portion; a connection frame connected between the lens fixing portion and the holder coupling portion; and a buffer space disposed between the lens fixing portion and the holder coupling portion and disposed at the lower portion of the connection frame,
wherein the buffer space horizontally overlaps a flange portion of one or two lenses of the first to third lenses adjacent to the sensor side, and
wherein the horizontal direction is orthogonal to the optical axis.

13. The camera module of claim 12, comprising a plurality of ribs connecting the lens fixing portion and the holder coupling portion along a surface of the connection frame.

14. The camera module of claim 12, wherein the lens barrel is made of plastic,
wherein the holder coupling portion of the lens barrel has a fastening portion that is screwed to the holder.

15. The camera module of claim 12, wherein the connection frame horizontally overlaps the spacing member between the second lens and the third lens,
wherein a thickness of the connection frame is thinner than a thickness of the spacing member.

16. The camera module of claim 12, wherein a thickness of the connection frame is thinner than a thickness of at least one of flange portions of the first to third lenses.

17. The camera module of claim 12, wherein a height of the buffer space is equal to or greater than a distance from a lower end of the lens fixing portion to an object-side surface of a flange portion of the third lens.

18. The camera module of claim 12, wherein a height of the buffer space is equal to or greater than a distance from a lower end of the lens fixing portion to a sensor-side surface of a flange portion of the first lens.

19. The camera module of claim 12, wherein a width of the buffer space is a distance between the lens fixing portion and the holder coupling portion,
wherein the width is equal to or greater than a value of D×CTE×(maximum operating temperature−room temperature),
wherein D is a maximum outer diameter of the lens barrel,
wherein CTE is a coefficient of thermal expansion of the third lens,
wherein the maximum operating temperature is 80 degrees to 105 degrees Celsius, and
wherein the room temperature is 20 to 30 degrees Celsius.

20. The camera module of claim 1, wherein a width of the buffer space is a distance between the lens fixing portion and the holder coupling portion,
wherein the width is equal to or greater than a value of D×CTE×(maximum operating temperature−room temperature),
wherein D is a maximum outer diameter of the lens barrel,
wherein CTE is a coefficient of thermal expansion of the third lens,
wherein the maximum operating temperature is 80 degrees to 105 degrees Celsius, and
wherein the room temperature is 20 to 30 degrees Celsius.

21. The camera module of claim 1, wherein the lens barrel is made of plastic, and
wherein the holder coupling portion of the lens barrel has a fastening portion that is screwed to the holder.
